(19) United States
(12) Patent Application Publication
(10) Pub. No.: US 2014/0170581 A1
(43) Pub. Date: Jun. 19, 2014

(54) SHROUD FOR DE-ICING AIR MOTOR OF HOT MELT DISPENSING SYSTEM

(71) Applicant: GRACO MINNESOTA INC., Minneapolis, MN (US)

(72) Inventors: Michael J. Sebion, Apple Valley, MN (US); Nicholas D. Long, Broadview Heights, OH (US); Shaun M. Cook, Tampa, FL (US); Mark W. Sheahan, Inver Grove Heights, MN (US); Mark T. Weinberger, Mounds View, MN (US); Mark J. Brudevold, Fridley, MN (US); Joseph E. Tix, Hastings, MN (US); John S. Lihwa, Willowick, OH (US); Douglas B. Farrow, Plymouth, MN (US); Robert J. Lind, Robbinsdale, MN (US); Paul R. Quam, Brooklyn Center, MN (US); Daniel P. Ross, Maplewood, MN (US)

(73) Assignee: GRACO MINNESOTA INC., Minneapolis, MN (US)

(21) Appl. No.: 13/717,946

(22) Filed: Dec. 18, 2012

(51) Int. Cl. F27D 7/02

(52) U.S. Cl. CPC F27D 7/02
USPC 432/1; 432/199

(57) ABSTRACT

A heating system includes an air motor with an exhaust; a pump for a hot melt dispensing system and driven by the air motor; and a shroud enclosing at least a portion of the air motor and the pump to direct heat from the pump to the exhaust of the air motor.

### BACKGROUND

The present disclosure relates generally to systems for dispensing hot melt adhesive. More particularly, the present disclosure relates to pumps and air motors.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

According to the present invention, a heating system includes an air motor with an exhaust; a pump for a hot melt dispensing system and driven by the air motor; and a shroud enclosing at least a portion of the air motor and the pump to direct heat from the pump to the exhaust of the air motor.

A method of preventing freezing in an air motor includes driving a pump with an air motor to produce flow of a hot melt material; and directing heat derived from the pump to the air motor.

### BRIEF DESCRIPTION OF THE DRAWINGS

FIG. 1 is a schematic view of a system for dispensing hot melt adhesive.

### DETAILED DESCRIPTION

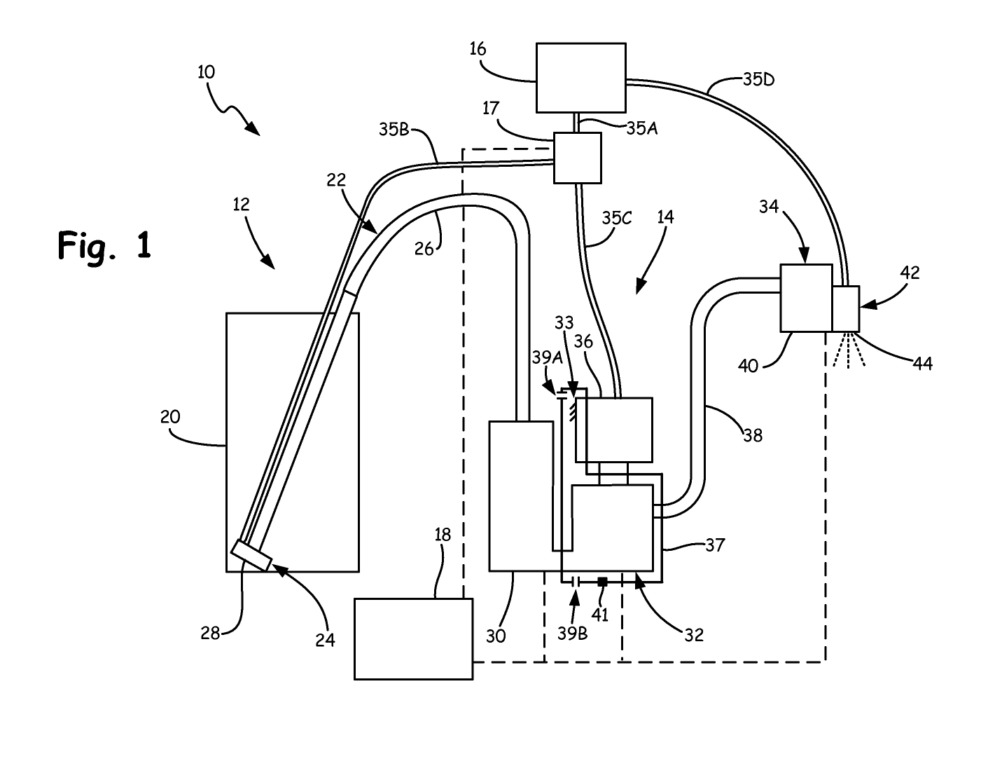

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, tie rod 31, pump 32 (with exhaust 33), dispenser 34 and shroud 37 (with vents 39a-39b and drain 41). Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

In the illustrated embodiment, dispenser 34 includes manifold 40 and module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is located below and is driven by motor 36 to pump hot melt adhesive from melt system 30, through supply hose 38, to dispenser 34. Pump 32 can be connected to motor 36 through tie rod 31. Pump 32 can be a linear displacement pump and can include one or more heating elements to maintain pump 32 temperature at desired hot melt temperature. An example of a heated pump is described in more detail in U.S. patent application Ser. No. 13/705,396, filed on Dec. 5, 2012 and titled “Heater Power Control System,” which is hereby incorporated by reference.

Motor 36 can be an air motor driven by compressed air from air source 16 and air control valve 17. Pressurized air is supplied to a chamber on one side of a piston, forcing the piston in one direction within the chamber. Once the piston is forced to one side, pressurized air is supplied to the chamber on the other side of the piston, pushing it in the other direction. This force is then imparted to the pump, driving the pump up and down to pump the hot melt to flow to dispenser 34. Each time the piston of the air motor changes direction, the air on one side of the piston must be evacuated from the chamber to allow the opposite side of the piston to fill with air and create force on pump 32. A more efficient motor 36 changes direction of its piston very quickly, resulting in air being forced out of the piston chamber very quickly. The quicker the evacuation of air, the colder the air will be as it expands quickly from the piston chamber to the exhaust. This quick evacuation sometimes results in freezing of moisture in the air around motor exhaust 33 and endcaps (not shown). Motor exhaust 33 includes fins, which can easily become plugged with frozen moisture, stalling motor.

Shroud 37 connects around pump 32 to enclose pump 32, and around the exhaust 33 of air motor 36. Shroud 37 can be made of metal (including alloys), for example, sheet metal or of a plastic material. Shroud can connect directly to pump 32 and/or motor 36 or could connect to tie rod 31. Shroud 37 could include drain 41 on the bottom and one or more vents 39a and 39b, including vent 39a near motor exhaust 33 and vent 39b at the bottom of shroud 37.

Shroud 37 acts to contain heat from pump 32. As mentioned above, pump 32 can contain one or more heating elements which can result in the temperature around pump 32 being about 350 degrees F. (449.8 degrees K). This heat radiating off pump 32 can be contained by shroud 37, and then directed toward air motor 36 and particularly toward exhaust 33 of air motor 36. The heat can be directed using convection based on the placement of pump 32 directly below motor 36. The placement of vents 39a and 39b could also assist in the convection by promoting the flow of heated air to exhaust 33. Additionally, a fan could be used within shroud, drawing air through vent 39b to promote convection. In alternate embodiments, pump 32 may not contain any heating elements and may simply radiate heat due to the hot melt flowing through pump 32. Drain 41 can allow for the removal of moisture within shroud 37, such as liquid from ice melted from exhaust 33.

By containing heat from pump 32, shroud 37 allows for the use of existing heat within system 10 to be used to help prevent air motor 36 stalls due to icing from motor 36 operation. This stall prevention allows for use of a more efficient air motor 36, which produces more consistent and accurate hot melt dispensing and reduced energy consumption within system 10.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

While the embodiment shown has shroud 37 completely enclosing pump 32 and only partly enclosing motor 36, in alternative embodiments, shroud 37 can enclose only part of pump 32 and/or could enclose all of motor 36.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A heating system comprising:
an air motor with an exhaust;
a pump for a hot melt dispensing system and driven by the air motor; and
a shroud enclosing at least a portion of the air motor and the pump to direct heat from the pump to the exhaust of the air motor.

2. The heating system of claim 1, wherein the shroud uses natural convection to direct heat from the pump to the exhaust of the air motor.

3. The heating system of claim 1, wherein the exhaust comprises exhaust fins.

4. The heating system of claim 1, wherein the shroud is a metallic material.

5. The heating system of claim 1, wherein the shroud is a plastic material.

6. The heating system of claim 1, and further comprising:
a tie rod connecting the pump to the air motor.

7. The heating system of claim 1, wherein the shroud connects to the tie rod.

8. The heating system of claim 1, wherein the pump is located below the motor.

9. A method comprising:
driving a pump with an air motor to produce flow of a hot melt material; and
preventing freezing in the air motor by directing heat derived from the pump to the air motor.

10. The method of claim 9, wherein the step of directing heat derived from the pump to the air motor comprises:
Containing heat from the pump with a shroud; and
Flowing heat contained by the shroud to the air motor.

11. The method of claim 9, wherein the pump radiates heat from a heating element.

12. The method of claim 9, wherein the pump radiates heat due to the hot melt material.

13. A hot melt dispensing system comprising:
a melter capable of heating hot melt pellets into a liquid;
a dispensing system with a pump driven by an air motor with an exhaust, the dispensing system is for administering liquefied hot melt pellets from the melter; and
a shroud to contain heat from the pump and direct the heat toward the air motor exhaust.

14. The system of claim 13, wherein the shroud connects around the pump and a portion of the air motor.

15. The system of claim 13, wherein the pump is located beneath the exhaust and the heat is directed toward the exhaust through natural convection.

16. The system of claim 13, wherein the exhaust comprises exhaust fins.

17. The system of claim 13, wherein the shroud is a metallic material.

18. The system of claim 13, wherein the shroud is a plastic material.

19. The system of claim 13, and further comprising:
a tie rod connecting the pump to the air motor.

20. The system of claim 19, wherein the shroud connects to the tie rod.
